(19) United States
(12) Patent Application Publication
(10) Pub. No.: US 2021/0143715 A1
(43) Pub. Date: May 13, 2021

(54) ROTOR FOR AN ELECTRICAL MACHINE, AND ELECTRICAL MACHINE

(71) Applicant: FEAAM GmbH, Neubiberg (DE)

(72) Inventor: Gurakuq DAJAKU, Neubiberg (DE)

(21) Appl. No.: 17/094,671

(22) Filed: Nov. 10, 2020

(30) Foreign Application Priority Data
Nov. 11, 2019 (DE) 10 2019 130 358.3

(51) Int. Cl. H02K 21/04

(52) U.S. Cl. CPC H02K 21/044

(57) ABSTRACT

A rotor (20) for an electrical machine (21) is provided, the rotor (20) comprising: a main rotor (22) which is rotatable around a longitudinal axis (z), and at least one auxiliary rotor (23) representing an axial flux rotor, wherein the auxiliary rotor (23) is also rotatable around the longitudinal axis (z) and is arranged along the longitudinal axis (z) so as to be adjacent to the main rotor (22), the auxiliary rotor (23) comprises at least one permanent magnet (24), and the permanent magnet (24) has at least in parts the shape of a ring. Further, an electrical machine (21) is provided.

The present application relates to a rotor for an electrical machine and to an electrical machine.

Typically, electrical machines comprise a stator and a rotor movable relative thereto. Electrical machines can be operated as a motor or as a generator, converting electrical energy into kinetic energy or vice versa. In operation, a magnetic field of the rotor interacts with a magnetic field of the stator.

The stator may have a distributed winding type. Electric machines with distributed windings are widely used in electric vehicles as prime movers. However, distributed windings have the disadvantage that the winding heads take up a lot of space along the axial machine length. This leaves less space along the axial machine length for the active length. This refers to the area that can be used to generate torque and power.

This inevitably means that this machine type is to be evaluated as inefficient, at least with regard to the utilization of the available installation space.

One task to be solved is to provide a rotor for an electrical machine, which can be operated efficiently. A further task to be solved is to provide an electrical machine which can be operated efficiently.

The tasks are solved by the objects of the independent claims. Advantageous designs and further developments are indicated in the subclaims.

According to at least one embodiment of the rotor for an electrical machine, the rotor comprises a main rotor which is rotatable around a longitudinal axis. The main rotor may have the shape of a cylinder. Furthermore, the main rotor may be arranged on a shaft of the electrical machine. The main rotor may be a claw pole type rotor with an excitation coil.

Furthermore, the rotor comprises at least one auxiliary rotor, which is an axial flux rotor. The auxiliary rotor may be in direct contact with the main rotor. The auxiliary rotor may be firmly connected to the main rotor. Thus, the main rotor and the auxiliary rotor always run at the same speed of rotation and have the same angle to each other. For example, the auxiliary rotor is glued to the main rotor.

The auxiliary rotor is also rotatable around the longitudinal axis and is arranged along the longitudinal axis so as to be adjacent to the main rotor.

The auxiliary rotor comprises at least one permanent magnet. The permanent magnet has a magnetic axis. The magnetic axis is parallel to the magnetization direction of the permanent magnet. This means that the magnetic axis connects the two poles of the permanent magnet. The permanent magnet may include rare earths or ferrite magnets. While rare earths enable a very high power density, ferrite magnets offer the advantage of lower costs.

The permanent magnet has the shape of a ring at least in parts. This may mean that at least a part of the permanent magnet has the shape of a ring. Furthermore, the permanent magnet may have further parts that do not have the shape of a ring. In other words, the permanent magnet may have different areas of which at least one has the shape of a ring. The different areas of the permanent magnet are connected to each other. For example, the different areas of the permanent magnet are connected by an adhesive. The permanent magnet may be formed in one piece. In this case, the permanent magnet has a particularly high mechanical strength. It is also possible that the permanent magnet has the shape of a ring. The diameter of the ring may be smaller than the diameter of the main rotor. The ring can be arranged around the shaft of the electric machine.

The rotor described here may be used in an electric machine comprising a stator with a distributed winding. In this case, the stator has an active length which is the area that may be used to generate torque and power. The winding heads of the distributed winding are arranged along the longitudinal axis besides the active length. The length of the main rotor along the longitudinal axis can be equal to the active length. The auxiliary rotor is thus arranged adjacent to the winding heads. This means that the auxiliary rotor is arranged around the longitudinal axis and the winding heads are arranged around the auxiliary rotor.

In this configuration of the electrical machine, the auxiliary rotor increases the magnetic flux density of the main rotor. This means that the magnetic flux density generated by the main rotor is amplified. During operation of the electric machine, the magnetic flux passes through the main rotor and the auxiliary rotor. Especially if the main rotor is a claw pole rotor, the flux density of the main rotor is increased by the arrangement of the auxiliary rotor next to the main rotor.

The effect of the auxiliary rotor may be increased by increasing the surface area of the permanent magnet of the auxiliary rotor in a cross-section through the rotor, with the longitudinal axis extending perpendicular to the cross-section through the rotor. This is achieved by the permanent magnet having the shape of a ring at least in parts. This allows the permanent magnet to cover a large surface area in the cross-section through the rotor. The permanent magnet may have further areas so that the surface area of the permanent magnet in the cross section through the rotor is further increased. In total, the volume of the permanent magnet is thus increased, which leads to an increased effect on the flux density of the main rotor. This means that the larger the volume of the permanent magnet, the more the flux density of the main rotor is increased. This leads to a higher torque and a higher power density of the electric machine. Thus, the electrical machine can be operated more efficiently.

According to at least one embodiment of the rotor, the main rotor is formed as a claw pole type rotor. The claw pole rotor may have an excitation coil. In a claw pole rotor, claws of two rotor halves alternately engage into each other. The two rotor halves are arranged in such a way that along the circumference of the claw pole type rotor a respective claw, which is designed as south pole, is arranged between two claws, which are designed as north pole. Thus, the north and south poles alternate along the circumference of the claw pole type rotor. The claws are arranged around the excitation coil. This means that the claws are arranged around the excitation coil in a cross-section through the main rotor. The excitation coil may have the shape of a ring. Advantageously, the at least one auxiliary rotor can increase the flux density of the claw pole type rotor.

According to at least one embodiment of the rotor, the rotor comprises a further auxiliary rotor, with the main rotor being arranged along the longitudinal axis between the auxiliary rotor and the further auxiliary rotor. The further auxiliary rotor may have the same structure as the auxiliary rotor. Along the longitudinal axis, the further auxiliary rotor may be arranged in the opposite direction to the auxiliary rotor. This means that, concerning the auxiliary rotor and the further auxiliary rotor, the permanent magnet faces the main rotor. By using the auxiliary rotor and the further auxiliary rotor, the flux density of the main rotor can be further increased. Advantageously, an auxiliary rotor is arranged on both sides of the main rotor along the longitudinal axis. Thus, the flux density of the main rotor may be increased more than with only one auxiliary rotor. The installation space in which the auxiliary rotor and the further auxiliary rotor are arranged is usually not intended for other parts of the rotor or of the electrical machine. Therefore, no further space is required to mount the auxiliary rotor and the further auxiliary rotor to the main rotor. This means that the efficiency of the electrical machine including the rotor can be increased without requiring more installation space.

According to at least one embodiment of the rotor, the magnetic axis of the permanent magnet extends parallel to the longitudinal axis. This means that the magnetic axis of the permanent magnet points either towards the main rotor or away from the main rotor. The magnetic axis of the permanent magnet of the auxiliary rotor may point in the same direction as the magnetic axis of the permanent magnet of the further auxiliary rotor. In this way, the flux density of the main rotor can be increased.

According to at least one embodiment of the rotor, the auxiliary rotor has a rotor core which has the shape of a ring at least in parts. The rotor core contains iron, for example. Thus, the rotor core serves as a rotor yoke. The permanent magnet is attached to the rotor core. The rotor core and the permanent magnet may be in direct contact. The fact that the rotor core has the shape of a ring at least in parts means that at least a part of the rotor core has the shape of a ring. Furthermore, the rotor core may have further parts that do not have the shape of a ring. In other words, the rotor core may have various areas of which at least one has the shape of a ring. The different areas of the rotor core are connected to each other. The rotor core may be formed in one piece. The diameter of the ring of the rotor core may be the same as the diameter of the main rotor. Since the auxiliary rotor has the permanent magnet and the rotor core, the flux density of the main rotor may be increased by the auxiliary rotor.

According to at least one embodiment of the rotor, the rotor core has teeth which extend toward the main rotor and are arranged to be spaced from each other. The teeth may also contain iron. The teeth are arranged along the circumference of the ring of the rotor core. Here, the teeth extend from the ring of the rotor core toward the main rotor. Along the longitudinal axis, the teeth of the rotor core extend further toward the main rotor than the permanent magnet. The teeth may be attached to the ring of the rotor core or they may be integral with it. The teeth of the rotor core are each assigned to a claw of the main rotor. Furthermore, the teeth of the rotor core may each be flush with a respective claw of the main rotor. Thus, the teeth of the rotor core may be connected to the main rotor. Advantageously, the teeth of the rotor core represent a path for the magnetic flux passing through the teeth of the rotor core into the main rotor. Thus, the flux density of the main rotor can be increased.

According to at least one embodiment of the rotor, the permanent magnet is arranged at least in parts along the longitudinal axis between the rotor core and the main rotor. The permanent magnet may be arranged along the longitudinal axis between the ring of the rotor core and the main rotor. The teeth of the rotor core may be in direct contact with the main rotor, so that the permanent magnet along the longitudinal axis is not arranged between the rotor core and the main rotor. The flux density of the main rotor can be increased by this design.

According to at least one embodiment of the rotor, the permanent magnet has recesses along its outer circumference which extend in the direction of the longitudinal axis partially through the permanent magnet. This means that the recesses extend from the outer circumference of the permanent magnet partially in the direction of the longitudinal axis. Thus, the recesses extend from the outer circumference of the permanent magnet in a radial direction partially in the direction of the longitudinal axis. The radial directions each extend perpendicular to the longitudinal axis. The teeth of the rotor core may be arranged in the recesses. This means that the rotor core and the permanent magnet may be flush with each other except for the areas of the recesses and the teeth. This shape of the permanent magnet maximizes the surface area of the permanent magnet in the cross-section through the rotor. This maximizes the volume of the permanent magnet and thus the flux density of the main rotor. This is why the electrical machine can be operated more efficiently. Furthermore, the shape of the auxiliary rotor may be adapted to the shape of the main rotor. To this end, the number of the recesses may be equal to the number of the pole pairs of the main rotor.

According to at least one embodiment of the rotor, the recesses are equal in size and have equal distances to each other. This means that the recesses along the circumference of the auxiliary rotor may be equal in size. Furthermore, the distances between the recesses along the circumference of the auxiliary rotor may be the same. Thus, the permanent magnet and the teeth of the rotor core may be adapted to the shape of the main rotor. This increases the flux density of the main rotor.

According to at least one embodiment of the rotor, further permanent magnets are connected to the permanent magnet, the further permanent magnets being arranged along the outer circumference of the permanent magnet so as to be spaced from each other. In this case, the permanent magnet has the shape of a ring. The further permanent magnets are arranged along the outer circumference of the ring. Thus, the further permanent magnets are attached to the permanent magnet. The permanent magnet with the further permanent magnets thus forms a ring, which has recesses along its outer circumference. These recesses extend from the outer circumference partially in the direction of the longitudinal axis. The further permanent magnets may be of the same size and have the same distances relative to each other. This means that the distances between the further permanent magnets along the circumference of the auxiliary rotor may be equal in size. This shape of the permanent magnet with the further permanent magnets maximizes the surface area, covered by permanent magnets, in the cross-section through the rotor. This maximizes the volume of the permanent magnet and thus the flux density of the main rotor. Therefore, the electrical machine may be operated more efficiently.

According to at least one embodiment of the rotor, the magnetic axes of the further permanent magnets extend parallel to the magnetic axis of the permanent magnet. Thus, the further permanent magnets also contribute to the amplification of the magnetic flux of the main rotor.

According to at least one embodiment of the rotor, the number of the further permanent magnets is equal to the number of the pole pairs of the main rotor. This is why the shape of the auxiliary rotor can be adapted to the shape of the main rotor. Each of the further permanent magnets may end flush with a claw of the claw pole type rotor. The flux density of the main rotor can be increased by this design.

Furthermore, an electrical machine is provided. According to at least one embodiment of the electrical machine, the electrical machine comprises the rotor. Thus, all features of the described rotor are also disclosed for the electrical machine, and vice versa. The electrical machine also has a stator. The rotor may be an internal rotor or an external rotor. If the rotor is an internal rotor, an outer side of the rotor faces the stator. The rotor may be arranged on a shaft of the electric machine. An air gap may be arranged between the stator and the rotor. The stator has a distributed winding or a concentrated winding.

According to at least one embodiment of the electrical machine, the stator has a winding with winding heads, with the main rotor extending as far as the area of the stator between the winding heads along the longitudinal axis. The winding including the winding heads is a distributed winding. The stator therefore has an active length that extends in the area between the winding heads. The active length is the area that may be used to generate torque and power. Along the longitudinal axis, the length of the main rotor thus corresponds to the active length. This means that the auxiliary rotor is arranged along the longitudinal axis outside the active length. Thus, the auxiliary rotor is arranged adjacent to the winding heads. In a cross-section through the electrical machine, which is parallel to the longitudinal axis, the auxiliary rotor is arranged between the winding heads. Along the longitudinal axis, the auxiliary rotor may extend approximately as far as the winding heads on one side of the stator. It is also possible that the auxiliary rotor extends along the longitudinal axis as far as the winding heads on one side of the stator. Without the use of the auxiliary rotor, the space in which the auxiliary rotor is arranged would not be used for torque generation. However, the auxiliary rotor contributes to an increase in the flux density of the main rotor. Thus, the electrical machine can be operated more efficiently.

In the following, the rotor described here and the electrical machine are explained in more detail in conjunction with exemplary embodiments and the corresponding Figures.

FIGS. 1A, 1B, 1C and 1D depict an exemplary embodiment of the rotor.

FIGS. 2A, 2B, 2C and 2D depict a further exemplary embodiment of the rotor.

FIGS. 3A, 3B, 3C and 3D depict a further exemplary embodiment of the rotor.

FIGS. 4A and 4B show an exemplary embodiment of the electrical machine.

FIG. 5 shows a schematic cross-section through a part of an exemplary embodiment of the electrical machine.

FIGS. 6A and 6B show an exemplary embodiment of the stator.

FIG. 7 shows a detail of an exemplary embodiment of the electrical machine.

FIG. 1A shows an exemplary embodiment of a rotor 20 for an electrical machine 21. Individual components of the rotor 20 are shown separately for better understanding. In the assembled state, the individual components form the exemplary embodiment of the rotor 20.

The rotor 20 has a main rotor 22 which is rotatable around a longitudinal axis z. The longitudinal axis z extends through the rotor 20. The main rotor 22 is a claw pole type rotor. The main rotor 22 has several claws 32 which are distributed along the circumference of the main rotor 22. Furthermore, the main rotor 22 has an excitation coil 39. The claws 32 are arranged around the excitation coil 39. The main rotor 22 has approximately the shape of a cylinder. The claws 32 each have a base area in the shape of a trapezoid. The base area extends along the circumference of the main rotor 22. The main rotor 22 has two end faces 33, which form the base areas of the cylinder. The claws 32 are arranged in such a way that one half of the claws 32 has the longer base of the base area of the trapezoid pointing toward one of the end faces 33 and the other half of the claws 32 has the shorter base of the base area pointing toward this end face 33. Thus, the claws 32 are alternately distributed along the circumference of the main rotor 22.

Moreover, the rotor 20 has an auxiliary rotor 23 and a further auxiliary rotor 25. The auxiliary rotor 23 is an axial flow rotor. In addition, the auxiliary rotor 23 can also be rotated about the longitudinal axis Z and is arranged along the longitudinal axis Z adjacent to the main rotor 22. The auxiliary rotor 23 comprises a permanent magnet 24 and a further permanent magnets 29. The permanent magnet 24 has the shape of a ring. The ring is arranged around the longitudinal axis z. Thus, the center of the ring lies on the longitudinal axis z.

The further permanent magnets 29 are connected to the permanent magnet 24. In this arrangement, the further permanent magnets 29 are arranged along the outer circumference of the permanent magnet 24 so as to be spaced from each other. The permanent magnet 24 with the further permanent magnets 29 thus form a ring which has recesses 28 along its outer circumference. The further permanent magnets 29 each have the same size and are arranged at equal distances from each other along the circumference of the permanent magnet 24. In addition, the magnetic axes of the further permanent magnets 29 extend parallel to the magnetic axis of the permanent magnet 24. The magnetic axis of the permanent magnet 24 is parallel to the longitudinal axis z. The permanent magnet 24 has a smaller extension along the longitudinal axis z than along a radial direction r, which is perpendicular to the longitudinal axis z. The further permanent magnets 29 also have a smaller extension along the longitudinal axis z than along a radial direction r.

The auxiliary rotor 23 also comprises a rotor core 26, which has the shape of a ring at least in parts. The rotor core 26 may contain iron and serve as a rotor yoke. The rotor core 26 also has teeth 27, which extend toward the main rotor 22 and are arranged to be spaced from each other. The teeth 27 are arranged on the outside of the rotor core 26. Furthermore, the teeth 27 are equally spaced along the circumference of the rotor core 26. The remaining part of the rotor core 26, apart from the teeth 27, has the shape of a ring. The ring of rotor core 26 has a smaller extension along the longitudinal axis z than along a radial direction r.

The permanent magnet 24 is arranged along the longitudinal axis z between the rotor core 26 and the main rotor 22. The teeth 27 of the rotor core 26 are in direct contact with the main rotor 22. This means that the permanent magnet 24 is not arranged between the teeth 27 of the rotor core 26 and the main rotor 22. In the assembled state, the teeth 27 extend through the gaps between the further permanent magnets 29 toward the main rotor 22. In addition, the permanent magnet 24 with the further permanent magnets 29 is in direct contact with the main rotor 22 in the assembled state. The individual components of the rotor 20 may be joined together by adhesive bonding.

When assembled, the further permanent magnets 29 are each flush with a longer base of the base area of a claw 32 of the main rotor 22. In the assembled state, the teeth 27 are also in direct contact with a shorter base of the base area of a claw 32. This is why the number of the further permanent magnets 29 is equal to the number of the pole pairs of the main rotor 22. Thus, during operation of the electric machine 21, the magnetic flux through claws 32 may extend further through the teeth 27 and the rotor core 26. This increases the magnetic flux density of the rotor 20.

The further auxiliary rotor 25 has the same structure as the auxiliary rotor 23 and is mounted on the main rotor 22 in the opposite direction as compared to the auxiliary rotor 23. The main rotor 22 is arranged along the longitudinal axis z between the auxiliary rotor 23 and the further auxiliary rotor 25. Thus, the permanent magnet 24 of the further auxiliary rotor 25 is arranged between the rotor core 26 of the further auxiliary rotor 25 and the main rotor 22. The auxiliary rotor 23 and the further auxiliary rotor 25 are arranged at opposite end faces 33 of the main rotor 22. Since the further permanent magnets 29 of the further auxiliary rotor 25 are also adapted to the claws 32 of the main rotor 22, the further auxiliary rotor 25 is turned around the longitudinal axis z by an angle relative to the auxiliary rotor 23.

The exemplary embodiment shown in FIG. 1A has the advantage that a large part of the surface area between the rotor core 26 and the main rotor 22 is filled by the permanent magnet 24 including the further permanent magnets 29. Thus, the permanent magnet 24 including the further permanent magnets 29 has a large volume, which results in an increased magnetic flux density of the main rotor 22.

FIG. 1B shows the exemplary embodiment of the permanent magnet 24 with the further permanent magnets 29 from FIG. 1A.

FIG. 1C shows the exemplary embodiment of the auxiliary rotor 23 from FIG. 1A. The permanent magnet 24 is connected to the further permanent magnets 29 including the rotor core 26. The teeth 27 of the rotor core 26 extend into the spaces between the further permanent magnets 29. Here, the teeth 27 are arranged to be spaced apart from the further permanent magnets 29. This means that the teeth 27 are not in direct contact with the further permanent magnets 29. The teeth 27 extend further along the longitudinal axis z than the permanent magnet 24 and the further permanent magnets 29.

FIG. 1D shows the embodiment of the rotor 20 from FIG. 1A. In contrast to the illustration in FIG. 1A, FIG. 1D shows the auxiliary rotor 23 and the further auxiliary rotor 25 in the assembled state.

FIG. 2A shows a further exemplary embodiment of the rotor 20. As in FIG. 1A, individual components of the rotor 20 are shown separately for better understanding. In contrast to the exemplary embodiment in FIG. 1A, the permanent magnet 24 has a different shape. In the exemplary embodiment in FIG. 2A, the permanent magnet 24 has the same shape as the permanent magnet 24 with the further permanent magnets 29 in FIG. 1A. This means that the permanent magnet 24 is formed in one piece. Furthermore, the further permanent magnet 24 has an area that has the shape of a ring. In addition, the permanent magnet 24 has the overall shape of a ring, which has recesses 28 along its outer circumference. The recesses 28 each extend partially from the outer circumference of the permanent magnet 24 in the direction of the longitudinal axis z through the permanent magnet 24. This means that the recesses 28 each extend along a radial direction r.

Compared to the exemplary embodiment shown in FIG. 1, the exemplary embodiment shown in FIG. 2A has a higher mechanical stability because the permanent magnet 24 has a higher mechanical stability. The latter is a one-piece construction and no further permanent magnets 29 are attached to the permanent magnet 24. This increases the mechanical stability of the permanent magnet 24. In addition, the rotor 20 shown in FIG. 2A has the same advantage as the rotor 20 shown in FIG. 1A, namely that the auxiliary rotor 23 and the further auxiliary rotor 25 increase the magnetic flux density in the main rotor 22.

FIG. 2B shows the exemplary embodiment of the permanent magnet 24 from FIG. 2A.

FIG. 2C shows the exemplary embodiment of the auxiliary rotor 23 from FIG. 2A. The permanent magnet 24 is connected to the rotor core 26. The teeth 27 of the rotor core 26 extend through the recesses 28. In this arrangement, the teeth 27 are arranged to be spaced apart from the permanent magnet 24. This means that the teeth 27 are not in direct contact with the permanent magnet 24. The teeth 27 extend further along the longitudinal axis z than the permanent magnet 24.

FIG. 2D shows the exemplary embodiment of the rotor 20 from FIG. 2A. In contrast to FIG. 2A, the auxiliary rotor 23 and the further auxiliary rotor 25 are shown in FIG. 2D in their assembled state.

FIG. 3A shows a further exemplary embodiment of the rotor 20. As in FIG. 1A, individual components of the rotor 20 are shown separately for better understanding. In contrast to the exemplary embodiment in FIG. 2A, the permanent magnet 24 has a different shape. The permanent magnet 24 has the shape of a ring. The remaining structure of the rotor 20 does not differ from the structure shown in FIG. 1A.

In this exemplary embodiment, the permanent magnet 24 also exhibits high mechanical stability. It can also be easily manufactured.

FIG. 3B shows the exemplary embodiment of the permanent magnet 24 from FIG. 3A.

FIG. 3C shows the exemplary embodiment of the auxiliary rotor 23 from FIG. 3A. The permanent magnet 24 is connected to the rotor core 26. The teeth 27 of the rotor core 26 are arranged around the outer circumference of the permanent magnet 24. The permanent magnet 24 is not arranged in the spaces between the teeth 27. The teeth 27 extend further along the longitudinal axis z than the permanent magnet 24.

FIG. 3D shows the exemplary embodiment of the rotor 20 from FIG. 3A. In contrast to the illustration in FIG. 3A, the auxiliary rotor 23 and the further auxiliary rotor 25 are shown in FIG. 3D in their assembled state.

FIG. 4A shows an exemplary embodiment of the electric machine 21. The electrical machine 21 has a stator 30 with a distributed winding 38. The winding 38 is arranged in grooves 37 of the stator 30. The grooves 37 are worked in a stator plate 36. The winding heads 31 of the winding 38 of the stator 30 protrude from the stator plate 36 on opposite sides. The area between the winding heads 31 of the stator 30 is the active length 34, which can be used to generate the torque. The rotor 20 is arranged in the stator 30. Here, the main rotor 22 ends with the active length 34 of stator 30. This means that the main rotor 22 extends along the longitudinal axis z as far as the area of the stator 30 between the winding heads 31. Adjacent to the winding heads 31, the auxiliary rotor 23 and the further auxiliary rotor 25 are arranged. This means that in a radial direction r the auxiliary rotor 23 is arranged next to the winding heads 31. The auxiliary rotor 23 has the permanent magnet 24 and the rotor core 26. The permanent magnet 24 is arranged here along the longitudinal axis z between the rotor core 26 and the main rotor 22.

FIG. 4B is a side view of the exemplary embodiment of the electrical machine 21 from FIG. 4A. The winding heads 31 protrude from the stator plate 36 on opposite sides. The area between the winding heads 31 along the longitudinal axis z is the active length 34 of the electrical machine 21.

FIG. 5 shows a schematic cross-section through a part of an exemplary embodiment of the electric machine 21. The cross-section through the electrical machine 21 extends along the longitudinal axis z. That part of the electrical machine 21 is shown which is on one side of the longitudinal axis z. The rotor 20 is arranged on a shaft 35 of the electrical machine 21. The shaft 35 extends parallel to the longitudinal axis Z. Along the longitudinal axis z, the main rotor 22 is arranged between the auxiliary rotor 23 and the further auxiliary rotor 25. The stator 30 is arranged around the main rotor 22. This means that the stator 30 is arranged above the main rotor 22 in this view. The winding heads 31 protrude from the stator plate 36 on opposite sides. The length of the main rotor 22 along the longitudinal axis z corresponds to the active length 34 of the stator 30. The auxiliary rotor 23 and the further auxiliary rotor 25 are arranged below the winding heads 31 in this view. Here, the auxiliary rotor 23 and the further auxiliary rotor 25 extend along the longitudinal axis z approximately as far as the winding heads 31.

FIG. 6A shows an exemplary embodiment of the stator 30. The stator 30 has a stator plate 36 with grooves 37 incorporated therein. The electric winding 38 of the stator 30 is arranged in the grooves 37. The winding heads 31 protrude from the stator plate 36.

FIG. 6B shows the exemplary embodiment of the stator 30 from FIG. 6A without the electric winding 38. A cross-section through the stator 30 is shown, said cross-section being perpendicular to the longitudinal axis z. The stator plate 36 has a large number of grooves 37, which are open towards the inside of the stator 30.

FIG. 7 shows a detail of an exemplary embodiment of the electric machine 21. A section through a plane is shown in which the longitudinal axis z extends. The rotor 20 is placed inside the stator 30. The stator 30 has the electric winding 38, with the winding heads 31 protruding from the stator plate 36 on opposite sides. The main rotor 22 is arranged along the active length 34 of stator 30. The claws 32 of the main rotor 22 are arranged around the excitation coil 39. The auxiliary rotor 23 and the further auxiliary rotor 25 are arranged on opposite sides of the main rotor 22. The auxiliary rotor 23 and the further auxiliary rotor 25 each have the permanent magnet 24 and the rotor core 26. The rotor core 26 comprises the teeth 27. The auxiliary rotor 23 and the further auxiliary rotor 25 are each attached to the main rotor 22.

1. A rotor for an electrical machine, the rotor comprising:
a main rotor which is rotatable around a longitudinal axis, and
at least one auxiliary rotor, which is an axial flux rotor, wherein
the auxiliary rotor is also rotatable around the longitudinal axis and is arranged along the longitudinal axis so as to be adjacent to the main rotor,
the auxiliary rotor comprises at least one permanent magnet, and
the permanent magnet has the shape of a ring at least in parts.

2. The rotor according to claim 1, in which the main rotor is formed as a claw pole type rotor having an excitation coil.

3. The rotor according to claim 1, which comprises a further auxiliary rotor, with the main rotor being arranged along the longitudinal axis between the auxiliary rotor and the further auxiliary rotor.

4. The rotor according to claim 1, in which the magnetic axis of the permanent magnet extends parallel to the longitudinal axis.

5. The rotor according to claim 1, in which the auxiliary rotor has a rotor core which has the shape of a ring at least in parts.

6. The rotor according to the preceding claim, in which the rotor core has teeth which extend toward the main rotor and are arranged to be spaced from one another.

7. The rotor according to any of claims 5 or 6, in which the permanent magnet is arranged at least in parts along the longitudinal axis between the rotor core and the main rotor.

8. The rotor according to claim 1, in which the permanent magnet has recesses along its outer circumference which extend in the direction of the longitudinal axis partially through the permanent magnet.

9. The rotor according to the preceding claim, in which the recesses are equal in size and have equal distances to each other.

10. The rotor according to claim 1, in which further permanent magnets are connected to the permanent magnet, the further permanent magnets being arranged along the outer circumference of the permanent magnet so as to be spaced from each other.

11. The rotor according to claim 1, in which the magnetic axes of the further permanent magnets extend parallel to the magnetic axis of the permanent magnet.

12. The rotor according to claim 1, in which the number of the further permanent magnets is equal to the number of the pole pairs of the main rotor.

13. An electrical machine comprising a rotor according to any of the claims 1 to 12 and a stator.

14. The electrical machine according to claim 13, in which the stator has a winding with winding heads, with the main rotor extending as far as the area of the stator between the winding heads along the longitudinal axis.
